(19) United States
(12) Patent Application Publication
(10) Pub. No.: US 2006/0005180 A1
(43) Pub. Date: Jan. 5, 2006

(54) Method and system for hot path detection and dynamic optimization

(76) Inventors: Ara V. Nefian, San Jose, CA (US); Ali-Reza Adl-Tabatabai, Santa Clara, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/881,147

(22) Filed: Jun. 30, 2004

(51) Int. Cl. G06F 9/44

(52) U.S. Cl. 717/158

(57) ABSTRACT

A method, apparatus and system including determining a distance between centers of at least two consecutive histogram bins, comparing the distance with a selected threshold value, determining major execution phases of an executable process based on the comparison, and filtering each buffer of sequenced buffers to detect hot buffers.

### BACKGROUND

1. Field

The embodiments relate to managed runtime computer system environment technology, and more particularly to dynamic detection of hot execution traces.

2. Description of the Related Art

Performance of processors is increasing at a much faster rate than the performance of associated attached memory subsystems. Therefore, it is increasingly difficult to input data to processors at a rate to keep the processors used to their maximum capacity. Thus, a great deal of effort has been spent on hardware solutions to improve the access time and throughput of memory references, including caches, prefetch buffers, branch prediction hardware, memory module interleaving, wide buses, etc. Additionally, software must be optimized to achieve the best possible advantage of the hardware.

Computer programs that are designed to run on managed runtime environments (MRTEs) are distributed in a neutral bytecode format and must be compiled to native machine code by a dynamic compiler. The performance of managed applications depends on the quality of optimization and code generation performed by a compiler. As the number of applications running on a system increases, the need for application optimization increases as well.

Many microprocessor architectures rely on compiler optimizations for performance. Some architectures rely heavily on expensive and sophisticated code-generation optimizations (such as global scheduling and control speculation) for performance. In order to optimize executable code, performance feedback and optimization techniques are used. The problem with these techniques is that they are usually intended for hardware implementations or are ad hoc, and thus not suitable for dynamic optimization or software implementations. Moreover, many optimizations require a wait-and-see approach as different optimization criteria are experimented with to achieve optimization. This can be time consuming and may only optimize an application for a short time due to system usage change.

### BRIEF DESCRIPTION OF THE DRAWINGS

The embodiments discussed herein generally relate to a method and system for detecting hot traces and process optimization. Referring to the figures, exemplary embodiments will now be described. The exemplary embodiments are provided to illustrate the embodiments and should not be construed as limiting the scope of the embodiments.

Reference in the specification to “an embodiment,” “one embodiment,” “some embodiments,” or “other embodiments” means that a particular feature, structure, or characteristic described in connection with the embodiments is included in at least some embodiments, but not necessarily all embodiments. The various appearances of “an embodiment,” “one embodiment,” or “some embodiments” are not necessarily all referring to the same embodiments. If the specification states a component, feature, structure, or characteristic “may”, “might”, or “could” be included, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

FIG. 1 illustrates one embodiment of a process to detect hot traces.

FIG. 2 illustrates a graph of an example buffer of branch trace buffers (BTrB) sample addresses over time.

FIG. 3 illustrates the histograms corresponding to two phases detected.

FIG. 4 illustrates the sequence of phases detected when using the data in FIG. 2.

FIG. 5 illustrates an embodiment of a system.

FIG. 6A illustrates a histogram for a first example of branch trace buffer samples filtered by significant bins.

FIG. 6B illustrates a histogram for the first example of branch trace buffer samples without being filtered by significant bins.

FIG. 7A illustrates a histogram for a second example of branch trace buffer samples filtered by significant bins.

FIG. 7B illustrates a histogram for the second example of branch trace buffer samples without being filtered by significant bins.

FIG. 8A illustrates a histogram for a third example of branch trace buffer samples filtered by significant bins.

FIG. 8B illustrates a histogram for the third example of branch trace buffer samples without being filtered by significant bins.

FIG. 9A illustrates a histogram for a fourth example of branch trace buffer samples filtered by significant bins.

FIG. 9B illustrates a histogram for the fourth example of branch trace buffer samples without being filtered by significant bins.

### DETAILED DESCRIPTION

The Embodiments discussed herein generally relate to a method and system for dynamically detecting hot execution traces. Referring to the figures, exemplary embodiments will now be described. The exemplary embodiments are provided to illustrate the embodiments and should not be construed as limiting the scope of the embodiments.

Systems that have dynamic profile guided optimizations (e.g., managed runtime environments, dynamic binary optimizers, and dynamic binary translators) try to determine when to dynamically re-optimize an executing program. Across the industry, it is becoming more common to use dynamic profiling to analyze program behavior during execution. Dynamic profiling gathers data about the frequencies with which different execution paths in a program are traversed. These profile data can then be fed back into the compiler to guide optimization of the code.

One of the proven uses of profile data is in determining the order in which instructions should be packaged. By discovering the “hot traces” through a procedure, the optimizer can pack the instructions in those traces together tightly into cache lines, resulting in greater cache utilization and fewer cache misses. Similarly, profile data can help determin+e which procedures call other procedures most frequently, permitting the called procedures to be reordered in memory to reduce page faults.

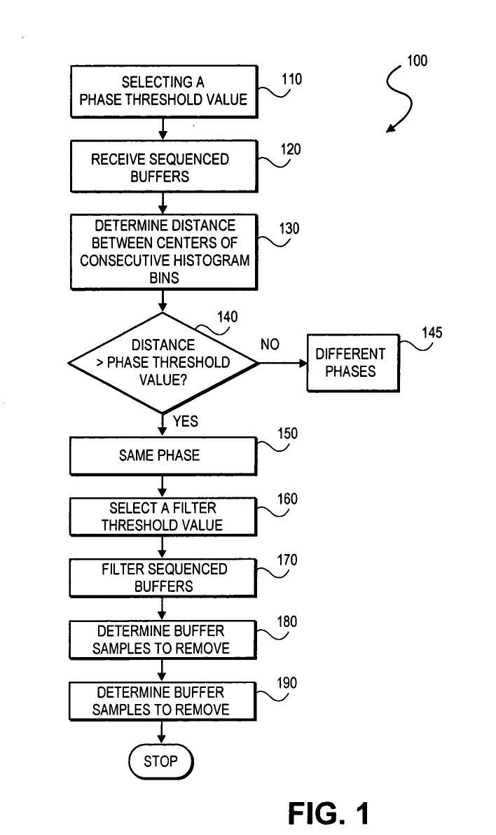

FIG. 1 illustrates one embodiment of a process to detect stable program phases for use in dynamic optimization of executable code. Process 100 begins at block 110 with selecting of a phase threshold value. The phase threshold value can be a function of a number of M consecutive samples of branch addresses sampled at a time t. In one embodiment a user selects the phase threshold value and enters the value as predetermined static parameters in a process. The phase threshold value can also be dynamically modified through a user input device as well.

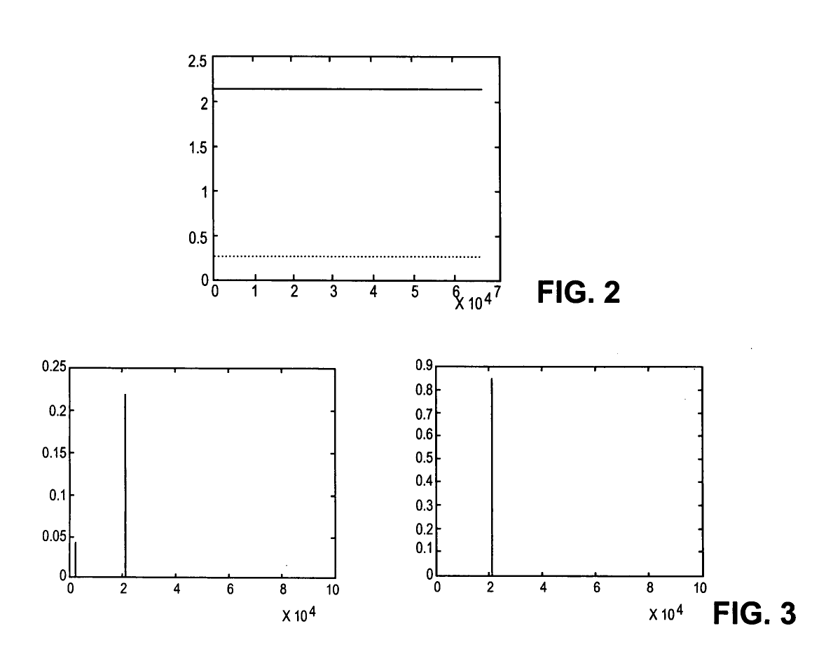

Process 100 continues with block 120. In block 120, a number of sequenced buffers are received. In one embodiment, a performance-monitoring unit (PMU) collects the sequenced branch trace buffers (BTrB). The sequenced buffers can be stored in local memory or in files. The buffers received include addresses of the last L branches taken. The value of L can be predetermined or selected by a user (e.g., 4, 8, 10, etc.). The buffers of the addresses of the branches taken are for a particular sampling moment in time. FIG. 2 illustrates a graph of an example buffer of BTrB sample addresses over time during execution of an example program, such as a benchmarking program.

After block 120 is complete process 100 continues with block 130. Block 130 determines a distance between centers of at least two consecutive histogram bins. In one embodiment a vector of branch addresses are determined as follows: bₜ=(b_{t,1}, . . . b_{t,L})^{T} is a vector of branch addresses representing a single BTrB sample at time t. Bₜ=bₜ, bₜ₊₁, . . . b_{tM} is a buffer of M consecutive samples made available at one moment of time. M is either predetermined or dynamically adjusted by a user, e.g., 1000, 1400, 1820, etc. A stable phase is defined as a one-dimensional histogram of Bₜ, and denoted as Hₜ=[h_{t,1}, . . . h_{t,N}]^{T}. The histogram Hₜ is a vector of size N where N is the total number of histogram bins. W₁, . . . W_{N} is a set of equally spaced and non-overlapping histogram bins that cover the entire space of possible branch addresses. ΔW=Wₖ−Wₖ₋₁ is the distance between the centers of two consecutive histogram bins. In one embodiment, a Euclidian distance calculation is used to measure distance, i.e. distance

$$( {H}_{k} , {H}_{l} ) = {[ {\sum }_{i = 1}^{N} {( {h}_{k , i} - {h}_{l , i} )}^{2} ]}^{0.5} .$$

It should be noted that other distance calculations known in the art can be used as well without deviating from the scope of the embodiments.

After block 130 has completed, block 140 compares the determined distance with the phase threshold value. If the distance between the two consecutive histogram bins is equal to or larger than the phase threshold value, then the samples in Bₖ and Bₗ belong to different phases, otherwise the samples belong to the same phase. Therefore, major execution phases of an executable process are determined based on the comparison result.

After block 140 is completed, process 100 continues with block 150 if the samples in Bₖ and Bₗ belong to the same phase. In one embodiment a variable indicating same phase is set. If the samples in Bₖ and Bₗ belong to the different phases, in one embodiment block 145 sets a variable indicating different phases.

Process 100 continues with the detection of hot traces. To detect hot traces, process 100 uses the sequence of buffers as input, each buffer containing M branch BTrB samples collected from a monitor, such as the PMU. Each BTrB sample contains the addresses of the last L branches taken at the sampling moment. After it is determined that execution has reached a phase with histogram Hₜ, each buffer Bₜ is analyzed to detect the set of hot BTrB samples.

In block 160 a significant bin threshold (filter threshold) value is selected, e.g. 0.1, 0.05, 0.2, etc. In one embodiment a user selects the threshold value and enters the value as predetermined static parameters in a process. The threshold value can also be dynamically modified through a user input device as well. In block 170 the BTrBs are filtered using the significant bin threshold value. The significant bins of the histogram Hₜ are the bins j for which

$${h}_{t , j} \geq {Thresh}_{bin} {max}_{i} {h}_{t , i} .$$

In block 180 the BTrB samples are removed for which at least one branch address falls outside the significant bins of Hₜ. For a sample vector of branch addresses to occur more times than a fixed selected filter threshold, all of its components must occur at least as many times. If one element of the vector occurs less frequently, the entire vector sample is filtered out.

In one embodiment, block 190 transmits a signal to re-optimize an executing process. The signal can be transmitted, for example, to a dynamic compiler for dynamic optimization. In another embodiment, process 100 is used to dynamically optimize an executing process(es) by detecting hot traces and forwarding the hot trace information to an optimization process, dynamic compiler, etc. for determining optimization parameters.

It should be noted that increasing the distance width of the histogram bins ΔW coarsens the resolution and decreases the complexity of phase detection process 100. A coarse resolution is used for phase detection while a fine resolution is used for hot trace detection. Setting ΔW=1 places every single branch address in a separate histogram bin. This creates a fine-grained histogram. The result of creating a fine-grained histogram is that phase detection process 100 slows down and potentially increases the number of phases. Setting ΔW>>1 places branch addresses that are in the same memory region into the same histogram bin. This results in creating a coarse-grained histogram. Creating a coarse grain histogram speeds up phase detection process 100 and reduces the number of phases. By varying the ΔW an analysis of the histograms at different resolutions can be made. Therefore a dynamic trade off of phase detection overhead with phase detection precision can be accomplished. In one embodiment process 100's determination of major execution phases is a dynamic process performed at a predetermined periodic rate. For example, process 100 can be performed at a chosen rate, such as every 5 minutes, hour, 24 hours, etc. In another embodiment, process 100 is manually performed as selected by a user.

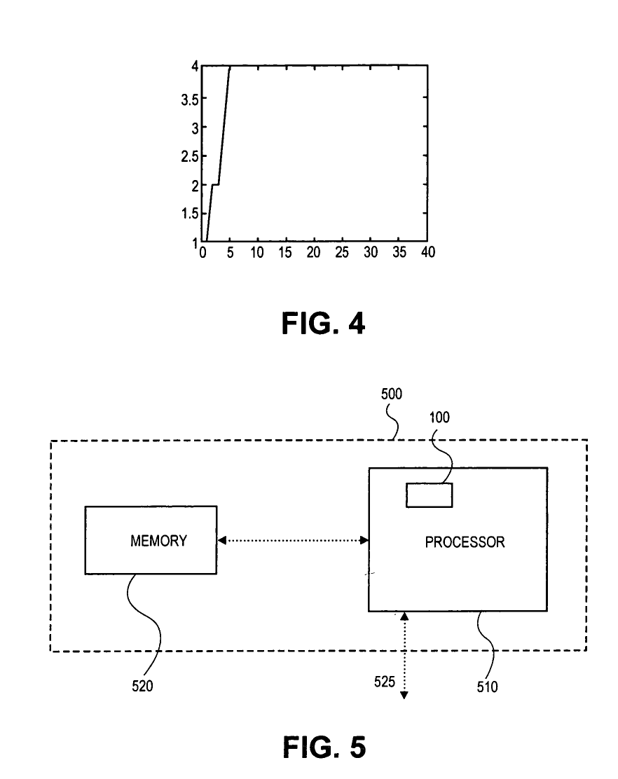

For example purposes, the graph illustrated in FIG. 2 of an example buffer of BTrB sample addresses over time during execution of an example program had the following settings: L=4, M=1820, ΔW=10⁵, and phase threshold=0.4M. FIG. 3 illustrates the histograms corresponding to two phases detected and FIG. 4 illustrates the sequence of phases detected when using the data in FIG. 2 for 37 blocks of data.

Process 100 can be used in systems that make use of dynamic profile guided optimizations, such as MRTEs, dynamic binary optimizers, and dynamic binary translators. These types of systems contain hardware performance monitoring and rely on profile-guided optimizations for performance.

FIG. 5 illustrates an embodiment of a system. System 500 includes processor 510 connected to memory 520 and process 100. In one embodiment memory 520 is a main memory, such as random-access memory (RAM), static random access memory (SRAM), dynamic random access memory (DRAM), synchronous DRAM (SDRAM), read-only memory (ROM), etc. In another embodiment, memory 520 is a cache memory. In one embodiment process 100 is in the form of an executable process running in processor 510 and communicating with memory 520. In one embodiment, process 100 includes two processes, one process is a phase detector, and the other is a hot trace detector. Process 100 includes a phase detector process that determines major execution phases and a hot trace detector that detects hot traces, of another executable process running on processor 500. In system 500, process 100 is used to determine when to re-optimize the other executable process running in system 500. System 500 can be combined with other known elements depending on the implementation. For example, if system 500 is used in a multiprocessor system, other known elements typical of multiprocessor systems would be coupled to system 500. System 500 can be used in a variety of implementations, such as personal computers (PCs), personal desk assistants (PDAs), notebook computers, servers, MRTEs, dynamic binary optimizers, dynamic binary translators, etc. In one embodiment, the phase detector process and hot trace detector exist as a hardware unit(s) having logic and a receiver to receive buffers. The logic elements of the phase and hot trace detectors include circuitry to perform the instructions that process 100 performs, as described above.

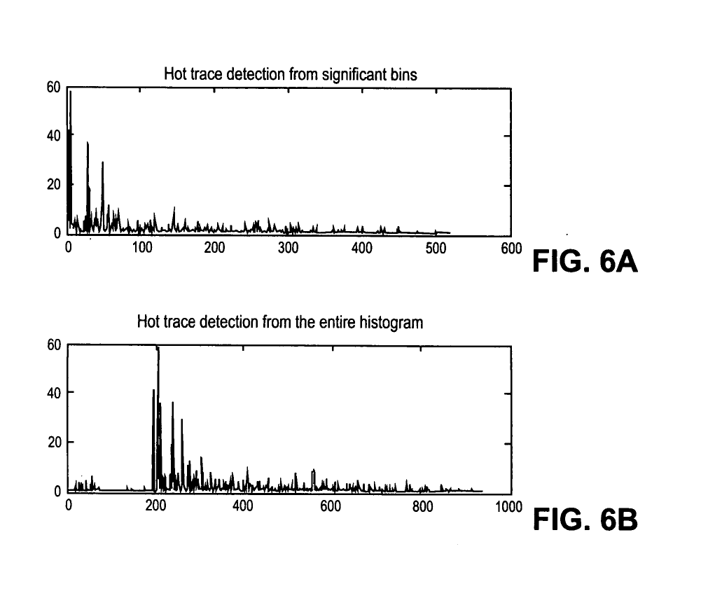

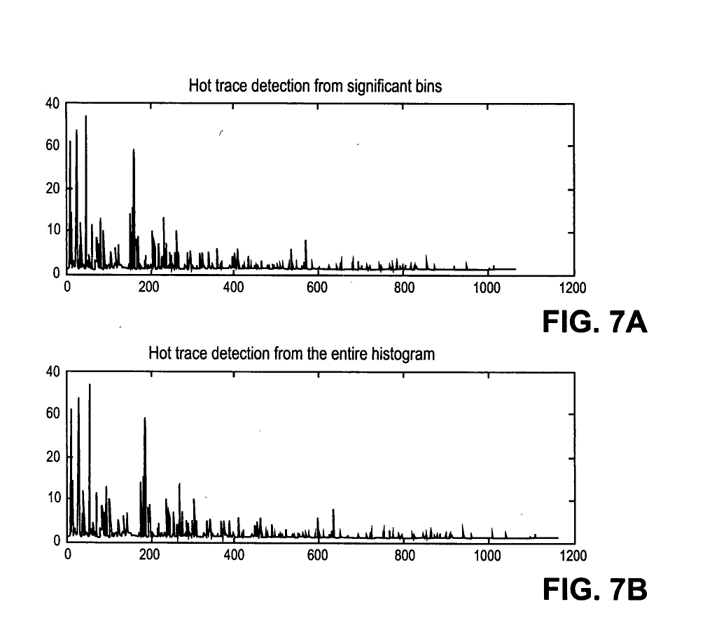

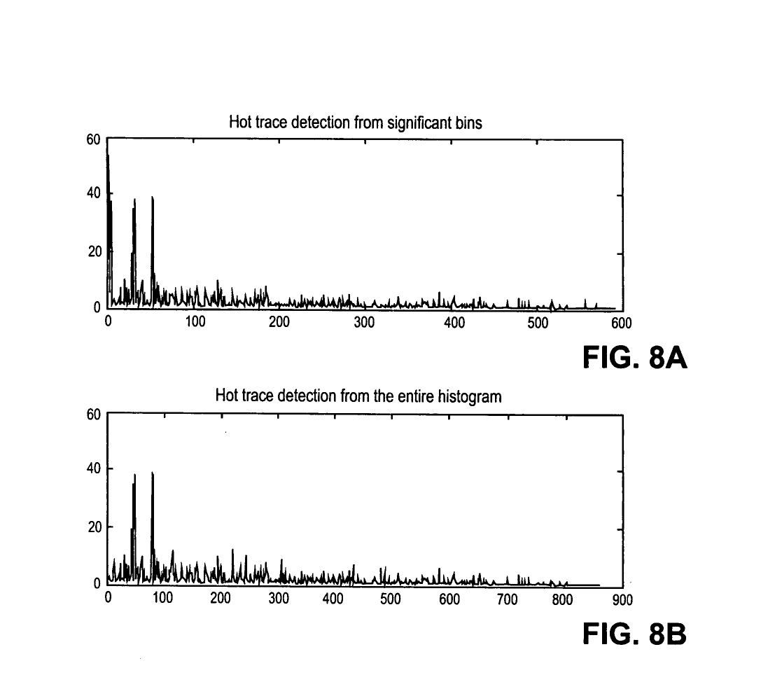

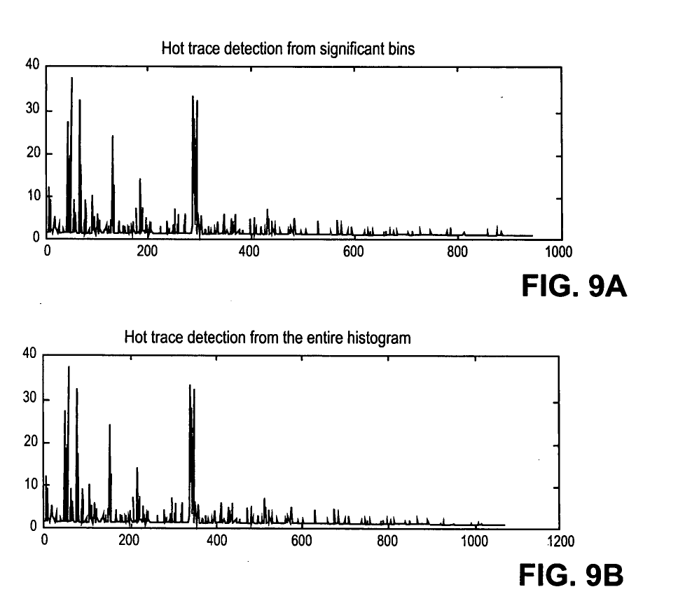

FIGS. 6A, 7A, 8A and 9A illustrate examples of BTrB sample histograms filtered by significant bins. FIGS. 6B, 7B, 8B and 9B illustrate examples of the BTrB sample histograms unfiltered by significant bins. The four examples are for four execution phases of a sample process. Note that each bin in the histograms corresponds to one BTrB sample, and that the size of the histograms of the hot samples after filtering are significantly smaller (i.e., 10%-50%) than the size of the unfiltered histograms while preserving all the significant peaks (hot samples). Process 100 allows for very efficient hot sample detection since process 100 only looks for the frequency of individual components of the samples vectors instead of the entire sample vectors.

The above embodiments can also be stored on a device or machine-readable medium and be read by a machine to perform instructions. The machine-readable medium includes any mechanism that provides (i.e., stores and/or transmits) information in a form readable by a machine (e.g., a computer). For example, a machine-readable medium includes read-only memory (ROM); random-access memory (RAM); magnetic disk storage media; optical storage media; flash memory devices; biological electrical, mechanical systems; electrical, optical, acoustical or other form of propagated signals (e.g., carrier waves, infrared signals, digital signals, etc.). The device or machine-readable medium may include a micro-electromechanical system (MEMS), nanotechnology devices, organic, holographic, solid-state memory device and/or a rotating magnetic or optical disk. The device or machine-readable medium may be distributed when partitions of instructions have been separated into different machines, such as across an interconnection of computers.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art.

What is claimed is:

1. A method comprising:
determining a distance between centers of at least two consecutive histogram bins;
comparing the distance with a selected phase threshold value;
determining major execution phases of an executable process based on the comparison, and
filtering each buffer in a plurality of sequenced buffers to detect hot buffers.

2. The method of claim 1, said plurality of sequenced buffers comprising samples containing addresses of a plurality of branches taken at a sampling time.

3. The method of claim 1, further comprising:
determining a plurality of branch addresses representing a branch trace buffer;
determining a plurality of consecutive branch addresses representing the branch trace buffer;
determining a stable phase histogram for the plurality of consecutive branch addresses, and
determining a plurality of equally spaced and non-overlapping histogram bins for all possible branch addresses.

4. The method of claim 1, where a detection of hot buffers is a requisite for dynamically optimizing executable code.

5. The method of claim 1, further comprising:
determining whether the at least two consecutive histogram bins are in the same phase.

6. The method of claim 5, said at least two consecutive histograms are in the same phase if said distance is less than one of equal to and less than said selected phase threshold value.

7. The method of claim 1, said filtering comprising:
selecting a filter threshold value, and
determining buffer samples in the plurality of sequenced buffers to remove based on said filter threshold.

8. A machine-accessible medium containing instructions that, when executed, cause a machine to:
determine a plurality of branch addresses representing a branch trace buffer;
determine a distance between centers of at least two consecutive histogram bins, where said at least two histogram bins are non-overlapping;
compare the distance with a selected threshold value, and
detect hot buffers by filtering each buffer in a plurality of sequenced buffers based on a filter threshold value.

9. The machine accessible medium of claim 8, said filtering further including instructions that, when executed, cause a machine to:
determine buffer samples in the plurality of sequenced buffers to remove based on said filter threshold value.

10. The machine accessible medium of claim 8, further containing instructions that, when executed, cause a machine to:
determine a plurality of consecutive branch addresses representing the branch trace buffer;
determine a stable phase histogram for the plurality of consecutive branch addresses;
determine a plurality of equally spaced and non-overlapping histogram bins for all possible branch addresses, and
determine major execution phases of an executable process based on the comparison.

11. The machine accessible medium of claim 10, wherein said determine major execution phases is dynamic at a predetermined periodic rate.

12. The machine accessible medium of claim 10, wherein said determine major execution phases is manually commenced.

13. The machine accessible medium of claim 8, said plurality of sequenced buffers comprising samples containing addresses of a plurality of branches taken at a sampling time.

14. The machine accessible medium of claim 10, where detection of hot buffers is a requisite for dynamically optimizing executable code.

15. The machine accessible medium of claim 10, further containing instructions that, when executed, cause a machine to:
determine whether the at least two consecutive histogram bins are in the same phase.

16. The machine accessible medium of claim 15, said at least two consecutive histograms are in the same phase if said distance is less than one of equal to and less than said selected phase threshold value.

17. A system comprising:
a processor coupled to one of a main memory and a cache memory;
a phase detector to determine major execution phases of at least one process, and
a hot trace detector,
wherein said hot trace detector including a filter to determine and remove buffer samples of a plurality of sequenced buffers.

18. The system of claim 17, wherein determined buffer samples are used to determine when to optimize executable code.

19. The system of claim 17, said phase detector and said hot trace detector each including a receiver to receive a plurality of sequenced buffers, wherein said phase detector to:
determine a plurality of branch addresses representing a branch trace buffer, to determine a distance between centers of at least two consecutive histogram bins, where said at least two histogram bins are non-overlapping, and to compare the distance with a predetermined threshold value.

20. The system of claim 19, said phase detector having logic to:
determine a plurality of consecutive branch addresses representing the branch trace buffer;
determine a stable phase histogram for the plurality of consecutive branch addresses, and
determine a plurality of equally spaced and non-overlapping histogram bins for all possible branch addresses.

21. The system of claim 17, wherein said phase detector having logic to determine major execution phases dynamically at a predetermined periodic rate.

22. The system of claim 19, said plurality of sequenced buffers comprising samples containing addresses of a plurality of branches taken at a sampling time.
